(19) United States
(12) Patent Application Publication
(10) Pub. No.: US 2003/0133220 A1
(43) Pub. Date: Jul. 17, 2003

(54) Written-in repeatable run-out compensation in embedded servo disc drives

(76) Inventor: Yi-Ping Hsin, Burnsville, MN (US)

Correspondence Address: David K. Lucente, Seagate Technology LLC, Intellectual Property - COL2LGL, 389 Disc Drive, Longmont, CO, 80503, US

(21) Appl. No.: 10/123,690

(22) Filed: Apr. 15, 2002

Related U.S. Application Data
(60) Provisional application No. 60/347,427, filed on Jan. 10, 2002.

(51) Int. Cl. G11B 5/596

(52) U.S. Cl. 360/77.04

(57) ABSTRACT

Another aspect of the present invention will now be explained. The comb-filter repetitive controller design of the present invention effectively eliminates periodic disturbances of a known period in the position measurements of the disc drive servo system. This is accomplished by merging the averaging ability of the frequency-domain batch process approach into the time-efficient repetitive control approach. An embodiment of the present invention uses a comb-filter incorporated with a real-time repetitive controller based on the real-time filtering concept. This comb-filter design adds the ability of separating the RRO and NRRO component from the PES during the real-time WI-RRO compensation process. This approach at least minimizes the incapability of the real-time repetitive control approach to identify the RRO component beforehand. Because the RRO component can be extracted even under a noisy PES condition using the present invention, the learning gain can be increased. Thus, the RRO compensation performance can reach that of the repetitive control approach with even less time being consumed.

### CROSS-REFERENCE TO RELATED APPLICATIONS

This application claims priority from U.S. Provisional Application No. 60/347,427 filed on Jan. 10, 2002, entitled “COMB-FILTER REPETITIVE CONTROLLER FOR REAL-TIME WRITTEN-IN REPEATABLE RUNOUT COMPENSATION IN EMBEDDED SERVO DISC DRIVES” and from U.S. patent application Ser. No. 10/017,930 filed on Dec. 12, 2001, entitled “WRITTEN-IN REPEATABLE RUN-OUT COMPENSATION IN EMBEDDED SERVO DISC DRIVES,” which claims priority from U.S. Provisional Application 60/310,397 filed on Aug. 6, 2001, entitled “REPETITIVE CONTROL APPROACH FOR WRITTEN-IN REPEATABLE RUN-OUT COMPENSATION IN EMBEDDED SERVO DISC DRIVES.”

### FIELD OF THE INVENTION

The present invention relates generally to servo systems in disc drives. In particular, the present invention relates to compensation for errors in servo systems.

### BACKGROUND OF THE INVENTION

Disc drives read and write information along concentric tracks formed on discs. To locate a particular track on a disc, disc drives typically use embedded servo fields on the disc. These embedded fields are utilized by a servo sub-system to position a head over a particular track. The servo fields are written onto the disc when the disc drive is manufactured and are thereafter simply read by the disc drive to determine position.

Ideally, a head following the center of a track moves along a perfectly circular path around the disc. However, two types of errors prevent heads from following this ideal path. The first type of error is a written-in error that arises during the creation of the servo fields. Written-in errors occur because the write head used to produce the servo fields does not always follow a perfectly circular path due to unpredictable pressure effects on the write head from the aerodynamics of its flight over the disc, and from vibrations in the gimbal used to support the head. Because of these written-in errors, a head that perfectly tracks the path followed by the servo write head will not follow a circular path.

The second type of error that prevents circular paths is known as track following error. Track following errors arise as a head attempts to follow the path defined by the servo fields. The track following errors can be caused by the same aerodynamic and vibrational effects that create written-in errors. In addition, track following errors can arise because the servo system is unable to respond fast enough to high-frequency changes in the path defined by the servo fields.

Written-in errors are often referred to as repeatable run-out errors because they cause the same errors each time the head passes along a track. As track densities increase, these repeatable run-out errors begin the limit the track pitch. Specifically, variations between the ideal track path and the actual track path created by the servo fields can result in a track interfering with or squeezing an adjacent track. This is especially acute when a first written-in error causes a head to be outside of an inner track's ideal circular path and a second written-in error causes the head to be inside of an outer track's ideal circular path. To avoid limitations on the track pitch, systems that compensate for repeatable run-out errors are employed.

The written-in repeatable runout (WI-RRO) that exists in embedded servo disc drives can be treated as the repetitive measured noise with a constant period associated with the rotational speed of the disc drive spindle. The feedback position error signal (PES) is typically contaminated with such noise, which makes the track path difficult to follow by the actuator and results in a repeatable runout signal in the PES. The WI-RRO can be described as the same signal sequence repeatedly adding to the position measurements at each revolution. One existing technique for repeatable run-out error compensation involves obtaining a sequence of repeatable run-out values, computing compensation values based on the repeatable run-out values, and storing the compensation values in compensation tables. These compensation values are then injected into the servo loop to compensate for repeatable run-out errors. In this technique, the sequence of repeatable run-out errors is obtained by repeatedly following tracks on the discs over a number of revolutions and averaging the position error signals obtained at each servo field over all of the revolutions.

There are two main categories of techniques to compensate for such noise, also known as errors. The first category is the frequency-domain batch process approach described above. The advantage of such approach is that it can separate the approximate repeatable runout (RRO) component from the PES before the compensation update process by averaging a certain number of revolutions of PES data. The drawback is that the batch-type process requires more revolutions for WI-RRO compensation update and the frequency-domain computation is somewhat burdensome. In addition, the repeatable run-out compensation values cannot be obtained in real-time, during disc operation, by using this technique.

The other category is the time-domain real-time repetitive control approach. The advantage of this approach is that it can speed up the WI-RRO compensation update process by applying the PES data directly without off-line averaging. Fewer revolutions are needed in such approach compared to the batch process approach. The drawback is the difficulty in attempting to identify the WI-RRO precisely if the PES contains a large portion of non-repeatable runout (NRRO). In such a situation, the learning gain of the servo controller has to be decreased, which will inevitably slow the WI-RRO compensation process.

Aspects of the present invention provide solutions to these and other problems, and offer other advantages.

### SUMMARY OF THE INVENTION

The present embodiments relate to disc drive servo systems that employ a real-time adaptive repeatable run-out compensation scheme to compensate for written-in repeatable run-out errors in the servo system, thereby addressing the above-mentioned problems.

An apparatus and method of correcting for written-in repeatable run-out in a disc drive having a servo loop for positioning a head over a rotating disc is provided. The rotating disc has at least one data track and servo information recorded in a plurality of servo fields along the data track. An initial written-in repeatable run-out compensation value for each servo field is computed as a function of a position error signal generated for each servo field during a first revolution of the disc. The initial written-in repeatable run-out compensation value for each servo field is then injected into the servo loop during another revolution of the disc. A compensated position error signal for each servo field is computed as a function of the initial written-in repeatable run-out compensation value for each servo field. A refined written-in repeatable run-out compensation value for each servo field is then computed as a function of the compensated position error signal for each servo field.

A further aspect of the present invention provides a preferred comb filter in the servo loop. The comb filter preferably filters out a non-periodic portion of a contaminated measurement signal to avoid such signal influencing a learned profile for the WI-RRO.

These and various other features as well as advantages which characterize the present invention will be apparent upon reading of the following detailed description and review of the associated drawings.

### BRIEF DESCRIPTION OF THE DRAWINGS

FIG. 1 is a perspective view of a head-disc assembly (HDA) with which the present invention is useful.

FIG. 2 is a top view of a section of a disc showing an ideal track and a realized written-in track.

FIG. 3 is a block diagram of a servo loop.

FIG. 4 is a block diagram of a servo loop of an embodiment of the present invention.

FIG. 5 is a block diagram representing the structure of a repetitive control module.

FIG. 6 is a flow chart representing a method of correcting for written-in repeatable run-out in a disc drive in accordance with an embodiment of the present invention.

FIG. 7 is a frequency response plot of a sensitivity function of a test disc drive without written-in repeatable run-out compensation.

FIG. 8 is a frequency spectrum of position error signal measurements of the test disc drive without written-in repeatable run-out compensation.

FIG. 9 is a frequency response plot of the inverse sensitivity function and curve-fitting results of the test disc drive.

FIG. 10 is a frequency magnitude response plot of an FIR filter employed in the test disc drive.

FIG. 11 is a frequency domain stability criterion plot for a repetitive controller design for the test disc drive.

FIG. 12 is a plot of the root mean square of the position error signal at each repetition.

FIG. 13 is a plot showing the transition of position error values while the repetitive controller learns the periodic error components in the servo loop.

FIG. 14 is the frequency spectrum of the position error signal with the repetitive controller turned on.

FIG. 15 is a block diagram of another embodiment of the present invention.

FIG. 16 is a block diagram of another repetitive control module.

FIG. 17 shows a frequency response of the comb filter of the present invention.

FIG. 18 shows a frequency spectrum of the position error signal after utilizing the FIG. 16 embodiment of the present invention.

FIG. 19 is a graph showing final runout levels without WI-RRO compensation.

FIG. 20 is a graph showing final runout levels utilizing the FIG. 16 embodiment of the present invention.

FIG. 21 shows a frequency response of an alternative comb filter of the present invention.

### DETAILED DESCRIPTION OF ILLUSTRATIVE EMBODIMENTS

While this invention is susceptible of embodiment in many different forms, there is shown in the drawings and will be described herein in detail specific embodiments thereof with the understanding that the present disclosure is to be considered as an exemplification of the principles of the invention and is not to be limited to the specific embodiments described.

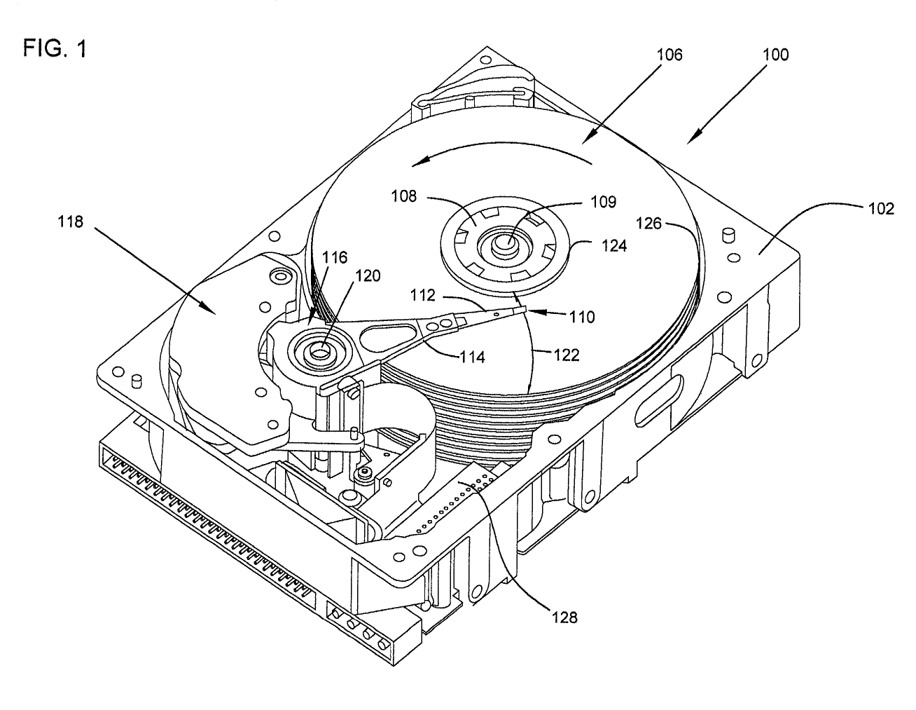

Referring now to FIG. 1, a perspective view of a head-disc assembly (HDA) 100 with which the present invention is useful is shown. The same reference numerals are used in various figures to represent same or similar elements. HDA 100 includes a housing with a base 102 and a top cover (not shown). HDA 100 further includes the disc pack 106, which is mounted on a spindle motor (not shown) by a disc clamp 108. Disc pack 106 includes a plurality of individual discs which are mounted for co-rotation about central axis 109.

Each disc surface has an associated slider 110 which is mounted in HDA 100 and carries a read/write head for communication with the disc surface. In the example shown in FIG. 1, sliders 110 are supported by suspensions 112 which are, in turn, supported by track accessing arms 114 of an actuator 116. The actuator shown in FIG. 1 is of the type known as a rotary moving coil actuator and includes a voice coil motor (VCM), shown generally as 118. Other types of actuators can be used, such as linear actuators.

VCM 118 rotates actuator 116 with its attached sliders 110 about a pivot shaft 120 to position sliders 110 over a desired data track along a path 122 between a disc inner diameter 124 and a disc outer diameter 126. VCM 118 operates under the control of a closed-loop servo controller within internal circuitry 128 based on position information, which is stored on one or more of the disc surfaces within dedicated servo fields. The servo fields can be interleaved with data sectors on each disc surface or can be located on a single disc surface that is dedicated to storing servo information. As slider 110 passes over the servo fields, the read/write head generates a readback signal that identifies the location of the head relative to the center line of the desired track. Based on this location, actuator 116 moves suspension 112 to adjust the head's position so that it moves toward the desired position. Once the transducing head is appropriately positioned, servo controller 128 then executes the desired read or write operation.

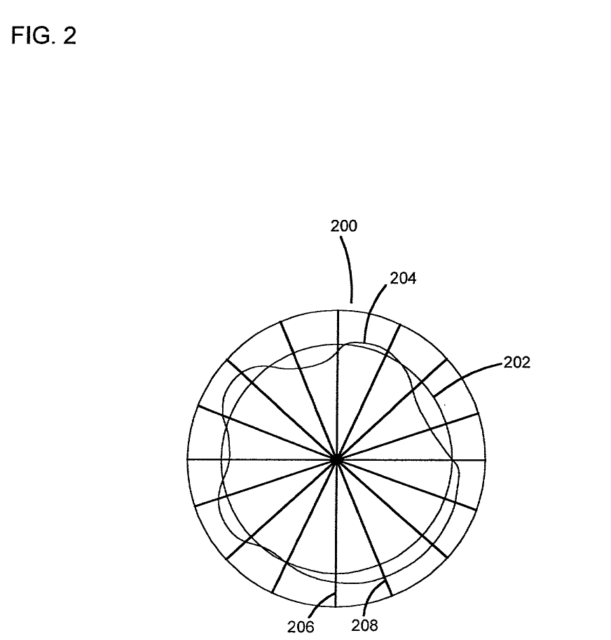

Referring now to FIG. 2, a top view of a section 200 of a disc with an ideal, perfectly circular track 202 and an actual track 204 is shown. Section 200 includes a plurality of radially extending servo fields such as servo fields 206 and 208. The servo fields include servo information that identifies the location of actual track 204 along disc section 200. Any variation in the position of a head away from circular track 202 is considered as position error. The portions of track 204 that do not follow circular track 202 create written-in repeatable run-out position errors. A position error is considered a repeatable run-out error if the same error occurs each time the head passes a particular circumferential location on the disc. Track 204 creates a repeatable run-out error because each time a head follows the servo fields that define track 204, it produces the same position error relative to ideal track 202.

Under the present invention, a head attempting to write to or read from track 204 will not follow track 204 but instead, will more closely follow perfectly circular track 202. This is accomplished using a compensation signal that prevents the servo system from tracking repeatable run-out errors resulting from the irregular shape of track 204.

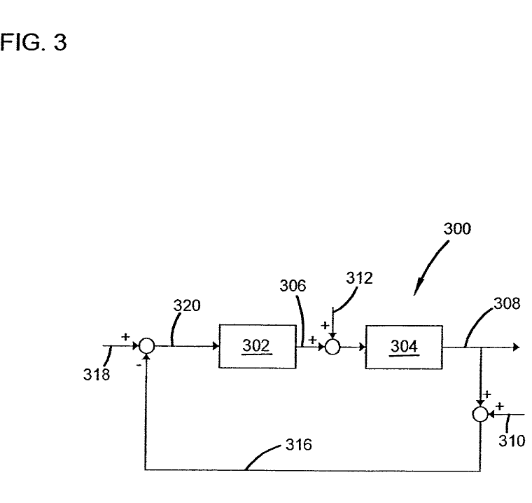

Referring now to FIG. 3, a block diagram of a servo loop 300 is shown. The servo loop includes a servo controller 302, having a transfer function K(z) and an actuator 304 having a transfer function P(z). Servo controller 302 is a part of the internal circuitry within internal circuit 128 of FIG. 1. Actuator 304 includes actuator assembly 116, voice coil motor 118, track accessing arm 114, suspension 112, and sliders 110, all of FIG. 1.

Servo controller 302 generates a control signal 306 that drives the actuator 304. In response, actuator 304 produces head motion 308. In FIG. 3, the written-in error, w(k), is represented as a separate input signal 310 even though the written-in error would otherwise appear implicitly in head motion 308. The separation of written-in error 310 from head motion 308 provides a better understanding of the present invention. In addition, noise, d(k), in the servo system has been separated and appears as noise 312, which is added to the control signal. The sum of head motion 308 that includes noise 312, and written-in error 310 results in the head's servo measurement signal, z(k), represented by reference numeral 316. Servo measurement signal 316 is subtracted from a reference signal, r(k), represented by reference numeral 318, which is generated by internal circuitry 128 based on a desired location for the head. Subtracting head measurement 316 from reference signal 318 produces a position error signal (PES), e(k), represented by reference numeral 320, which is input to servo controller 302.

PES 320 includes a repeatable run-out (RRO) error component and a non-repeatable run-out (NRRO) error component. RRO is caused by the rotation of the spindle motor and the written-in run-out at servo patterns. NRRO is caused by spindle ball bearing defects, rocking modes, disc vibration, etc. The statistical 3-σ values (where σ denotes the standard deviation) of the RRO, NRRO and PES measurements are used as disc drive performance indexes and have the following relationship:

σ_{PES} ²=σ_{RRO}²+σ_{NRRO}² Equation (1)

A Discrete Fourier Transform (DFT) of the PES shows the RRO components as distinct peaks at harmonics of the disc drive spindle rotational frequency. RRO components from rotation of the spindle motor dominate at the first few harmonics of the spindle frequency, and the remaining peaks up to the Nyquist frequency or sampling frequency (sampling occurs at each servo field) are all contributed from the written-in position error referred to as written-in repeatable run-out (WI-RRO).

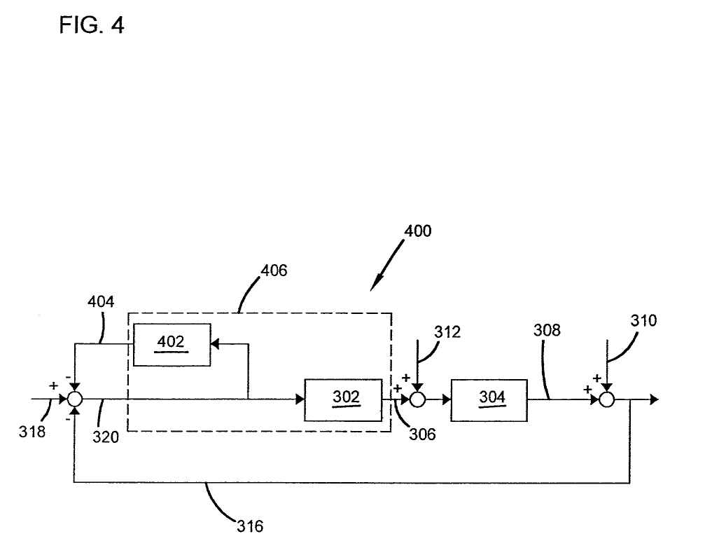

To eliminate the unwanted head motion created by WI-RRO, the present invention adds a compensation signal, produced by a repetitive control module, to the servo loop. Referring now to FIG. 4, a block diagram of a servo loop 400 of the present invention is shown. In FIG. 4, the elements common to FIG. 3 are numbered the same. The compensation signal added to the servo loop is compensation signal 404, which is produced by repetitive control module 402. Thus, controller 406 of the present invention includes servo controller 302 and repetitive control module 402. In FIG. 4, compensation signal 404 is inserted at the summation of reference signal 318 and servo measurement 316. However, those skilled in the art will recognize that the compensation signal can be added at other locations within the servo loop.

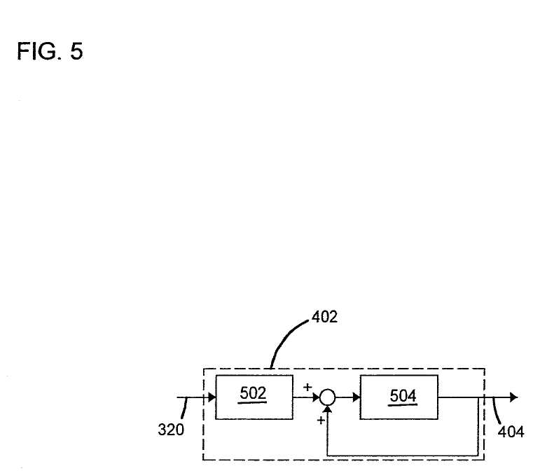

Repetitive control module 402 is designed to identify and learn the repeating WI-RRO sequence and to output compensation signal 404 which is added to servo loop 400 to attenuate the effect of WI-RRO. Since this technique involves learning the periodic WI-RRO disturbance, it usually takes several disc revolutions before compensation signal 404 converges to the WI-RRO profile. Details of the repetitive learning process are described further below. As it is unlikely that the WI-RRO on different tracks will be the same, the WI-RRO is preferably calculated for each track. Once the compensation signal values converge to the WI-RRO profile (i.e., when a set of steady state compensation values are obtained), they can be stored in compensation tables. These stored steady state compensation values can be injected into servo loop 400 for WI-RRO cancellation. The repetitive control module may be excluded from servo loop 400 once a set of steady state compensation values are obtained. Thus, repetitive control module 402 may be either permanently operating in servo loop 400 or may be temporarily included in the loop until a set of steady state WI-RRO compensation values are obtained. The design of repetitive control module 402 is described below in connection with FIGS. 4 and 5.

For simplification, transfer functions K(z) and P(z) will hereinafter be used to represent servo controller 302 and actuator 304, respectively. The sensitivity function or error function of a servo loop is the ability of the servo loop to attenuate disturbance. The closed-loop sensitivity function S(z) of servo loop 300 (FIG. 3) can be expressed as:

$$S ( z ) = \frac{1}{1 + K ( z ) P ( z )} \qquad Equation ( 2 )$$

Repetitive control module 402 (FIG. 4) is represented by transfer function L(z). PES, e(k), is the input to L(z) and the output of L(z) is compensation signal u(k) which is injected into the servo loop to attenuate the WI-RRO, w(k).

The repetitive control law used for the design of repetitive controller L(z) is as follows:

u(k)=q(k)*[u(k−p)+f(k)*e(k−p)] Equation (3)

where p is the disc revolution time period and q(k) and f(k) are filters used in the repetitive control module design. Taking the z-transform of Equation (3) results in the following expression:

U(z)=z^{-P}Q(z)[U(z)+F(z)E(z)] Equation (4)

which can be re-written as:

[1−z^{-P}Q(z)]U(z)=z^{-P}Q(z)F(z)E(z) Equation (5)

Combining terms of Equation (5) yields the repetitive controller transfer function, L(z), which is expressed as:

$$L ( z ) = \frac{U ( z )}{E ( z )} = \frac{{z}^{- p} Q ( z ) F ( z )}{1 - {z}^{- p} Q ( z )} \qquad Equation ( 6 )$$

A block diagram showing details of the repetitive controller L(z) is shown in FIG. 5. The input to the repetitive control module 402 is PES, e(k), represented by reference numeral 320. Block 502 represents a first filter F(z) and block 504 represents z^{-P}Q(z), where Q(z) is a second filter. As can be seen in FIG. 5, the repetitive controller output, u(k), represented by reference numeral 404, is fed back to a summing node between blocks 502 and 504.

From the block diagram in FIG. 5, the sensitivity function expressed by Equation (2), and the transfer function of the repetitive controller represented by Equation (6), it can be derived that

{1−z^{-P}Q(z)[1−F(z)S(z)]}E(z)=[1−z^{-P}Q(z)][R(z)−W(z)−P(z)D(z)]S(z) Equation (7)

Provided that period p is sufficiently long, the homogeneous equation on the left-hand side of Equation (7) can be re-written as:

E(z)=Q(z)[1−F(z)S(z)]z^{-P}E(z) Equation (8)

Equation (8) can be represented in the repetition domain as:

Eⱼ(z)=Q(z)[1−F(z)S(z)]Eⱼ₋₁(z) Equation (9)

where j represents the repetition number. The condition needed for producing monotonic decay of every steady-state discrete frequency component of the WI-RRO at each repetition is

|Q(e^{jωT})[1−F(e^{jωT})S(e^{jωT})]<1 Equation (10)

Here Q(e^{jωT}) and F(e^{jωT}) are the steady-state frequency response for the repetitive control law given by q(k) and f (k) (Equation (3)), and S(e^{jωT}) is the steady-state frequency response of the sensitivity function of servo loop 300. The term on the left-hand side of Equation (10) also gives the convergence rate of the periodic WI-RRO at each frequency. The right-hand side of Equation (7) represents the forcing function for letting E(z) converge to a particular solution.

Filter F(z) is designed to adjust the magnitude and phase of input error in order to stabilize the learning process. Q(z) is usually designed as a zero-phase FIR filter to control the learning frequency range.

From the right-hand side of Equation (7) it follows that the forcing function of the periodic disturbance W(z) can only be totally cancelled out by choosing Q(z)=1. Also, from Equation (7) it follows that the design of F(z) for the fastest convergence of the periodic error is

F(z)=S⁻¹(z) Equation (11)

which is equivalent to the inverse of the system sensitivity function S(z) (Equation (2)). In practice, to reduce the amplification of random noise d(k) at the neighborhood frequencies of spindle harmonics, which is called “water bed effect”, the filter F(z) is modified as:

F(z)=c·S⁻¹(z) Equation (12)

where c is a constant gain within the range 0<c<1.

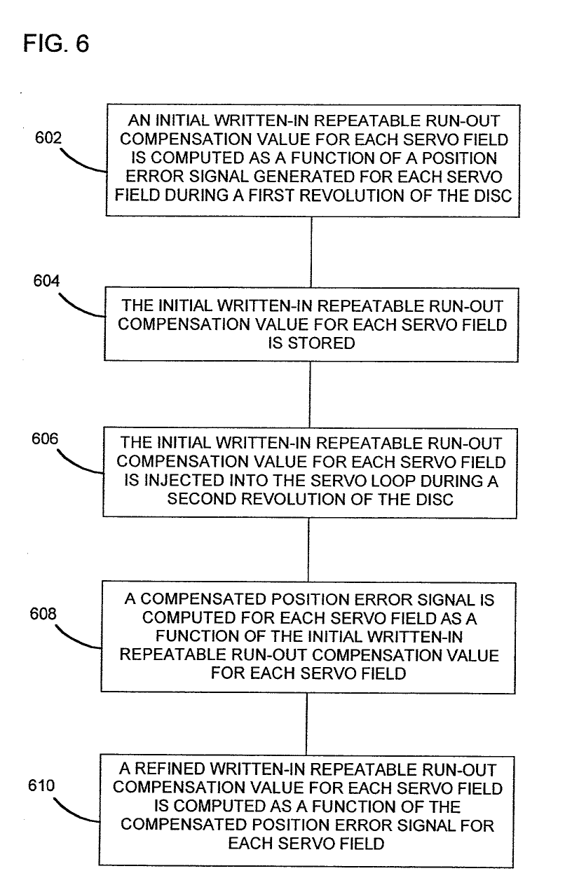

FIG. 6 is a flow chart representing a method of correcting for written-in repeatable run-out in a disc drive having a servo loop for positioning a head over a rotating disc in accordance with an illustrative embodiment of the present invention. The rotating disc has at least one data track and servo information recorded in a plurality of servo fields along the data track. At step 602, an initial written-in repeatable run-out compensation value for each servo field is computed as a function of a position error signal generated for each servo field during a first revolution of the disc. At step 604, the initial written-in repeatable run-out compensation value for each servo field is stored. At step 606, the initial written-in repeatable run-out compensation value for each servo field is injected into the servo loop during a second revolution of the disc. At step 608, a compensated position error signal for each servo field is computed as a function of the initial written-in repeatable run-out compensation value for each servo field. At step 610, a refined written-in repeatable run-out compensation value for each servo field is then computed as a function of the compensated position error signal for each servo field. Preferably, steps 604, 606, 608 and 610 are repeated iteratively until the refined written-in repeatable run-out compensation value for each servo field reaches a steady state written-in repeatable run-out compensation value. A stored steady state written-in repeatable run-out compensation value for each servo field is used to provide compensation during subsequent disc revolutions.

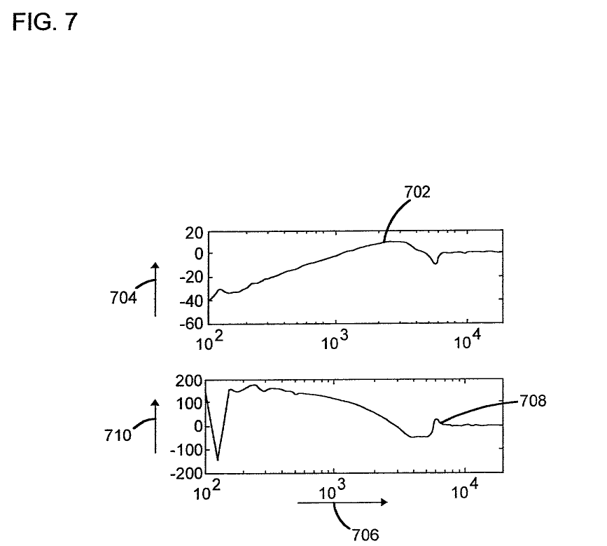

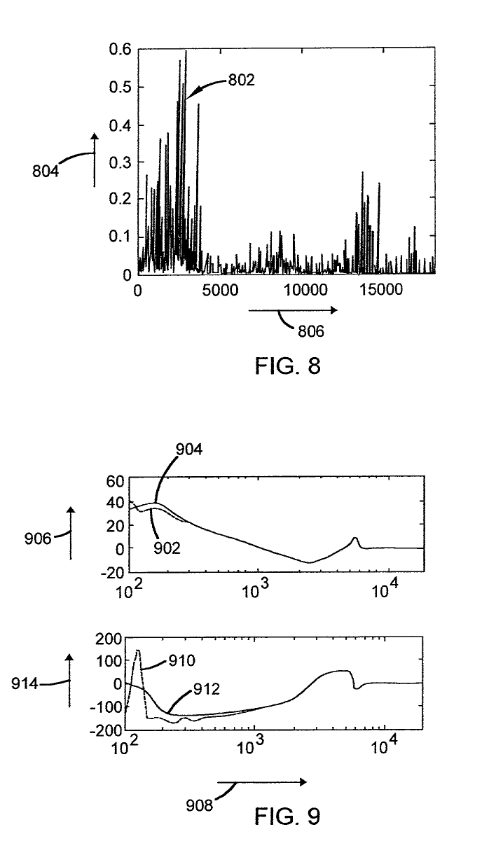

The repetitive control scheme for periodic WI-RRO cancellation, described above, was applied to a disc drive having a spindle rotational speed of 10,041 RPM and 224 servo fields. The spindle frequency was 167.35 Hertz (Hz) and the servo sampling frequency was 37,486 Hz (167.35×224). The sampling time was 26.7 μsec and the learning time period p was 224 time steps in the repetitive controller design. The frequency response of the closed-loop sensitivity function S(z), defined by Equation (2), was obtained before the inclusion of the repetitive control module. FIG. 7 shows the frequency response of S(z). Plot 702 is a trace of the magnitude of S(z) in decibels (dB) along vertical axis 704 as a function of frequency in Hz along horizontal axis 706. Plot 708 is a trace of phase in degrees (deg) along vertical axis 710 as a function of frequency in Hz along horizontal axis 706. The frequency spectrum of the PES measurements from the disc drive, without the inclusion of the repetitive controller, is shown in FIG. 8. Plot 802 is a trace of the amplitude of the PES in micro inches (μ-in) along vertical axis 804 as a function of frequency in Hz along horizontal axis 806. The distinct peaks located at the multiples of fundamental spindle frequency 167.35 Hz clearly shows the effect of WI-RRO on the PES.

The purpose of the repetitive controller is to compensate for the WI-RRO as accurately as possible in a finite number of revolutions. The learning law of Equation (6) was used to design the repetitive controller. Filter F(z) was designed in accordance with Equation (12) and the constant gain was set to c=0.2. The parametric transfer function of the sensitivity function inverse S⁻¹(z) required in this design was approximated by a frequency domain curve-fitting scheme applied to the reciprocal of the frequency response of S(z). A 6^{th} order IIR filter was used for curve-fitting and the resulting transfer function \overline{S}⁻¹(z) obtained was

$${\overline{S}}^{- 1} ( z ) = \frac{0.99 {z}^{6} - 3.77 {z}^{5} + 6.49 {z}^{4} - 6.47 {z}^{3} + 3.89 {z}^{2} - 1.28 z + 0.16}{{z}^{6} - 3.78 {z}^{5} + 6.52 {z}^{4} - 6.61 {z}^{3} + 4.06 {z}^{2} - 1.45 z + 0.26} \qquad Equation ( 13 )$$

The frequency response of S⁻¹(z) and curve-fitting results are shown in FIG. 9. Plots 902 and 904 are each traces of the magnitude of S⁻¹(z) and \overline{S}⁻¹(z) in dB along vertical axis 906 as a function of frequency in Hz along horizontal axis 908. Plots 910 and 912 are each traces of the phase of S⁻¹(z) and \overline{S}⁻¹(z) in deg, respectively, along vertical axis 914 as a function of frequency in Hz along horizontal axis 908. The final design of F(z) selected was

F(z)=0.2×\overline{S}⁻¹(z) Equation (14)

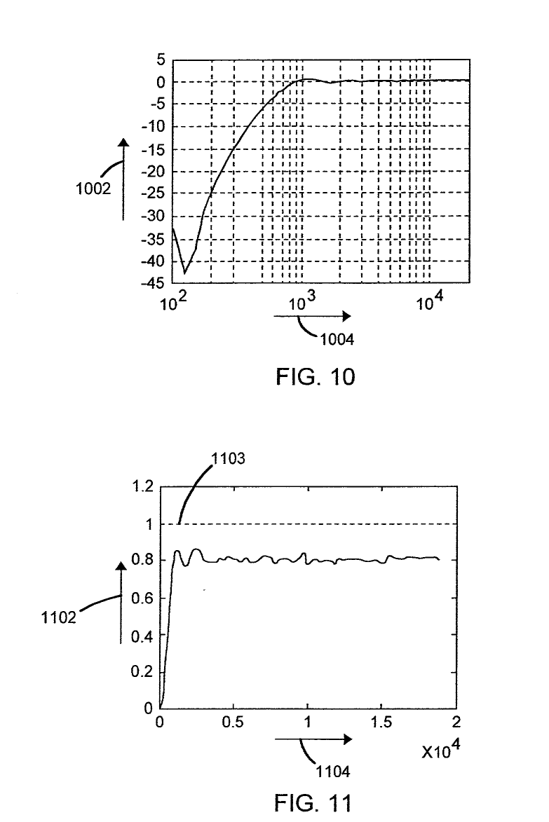

Even through the phase of fitted transfer function \overline{S}⁻¹(z) deviates from the actual system S⁻¹(z) at a low frequency region as shown in FIG. 9, the learning process can still be stabilized if a second filter Q(z) is introduced to satisfy the stability criterion in Equation (10). The second filter Q(z) in this application was designed as a 60^{th} order high-pass FIR filter with cut-off frequency at 600 Hz. FIG. 10 shows a frequency magnitude response of Q(z) with magnitude in dB plotted along vertical axis 1002 as a function of frequency in Hz along horizontal axis 1004. FIG. 11 is the frequency domain stability criterion plot of |Q(e^{jωT})[1−F(e^{jωT})S(e^{jωT}) ] along vertical axis 1102 as a function of frequency along horizontal axis 1104. As can be seen in FIG. 11, the magnitudes of |Q(e^{jωT})[1−F(e^{jωT})S(e^{jωT})] are far lower than 1 for the entire frequency region without a chance to cross the stability boundary 1103, thereby satisfying the stability criterion in Equation (10). Another purpose of Q(z) is to avoid learning the peaks at the 1^{st}, 2^{nd}, and 3^{rd} harmonics caused by the spindle motor but not the WI-RRO.

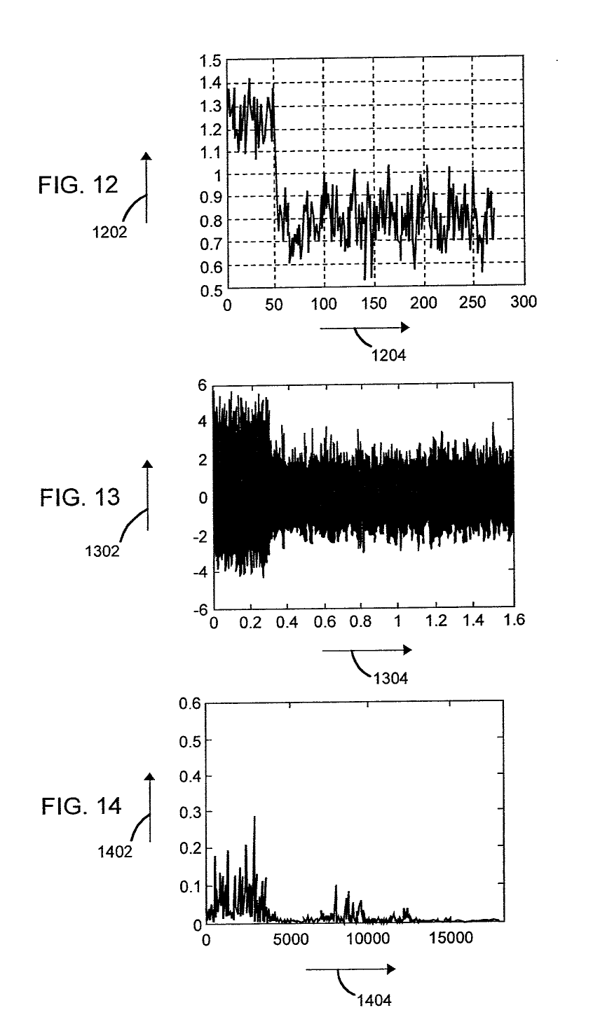

FIG. 12 is a plot of the root mean square (RMS) of the PES at every repetition. The RMS in μ-in is plotted along vertical axis 1202 as a function of repetition number along horizontal axis 1204. The repetitive controller was turned on at repetition 50. The plot shows the monotonic decay of the PES during the learning process in 20 repetitions and the maintenance of the same error level thereafter. FIG. 13 is a plot of the transition of the PES during the learning process. PES in μ-in is plotted along vertical axis 1302 as a function of time in seconds (sec) along horizontal axis 1304. The plot shows that the PES was sharply reduced after repetition 50 (about 0.3 sec). FIG. 14 is the frequency spectrum of the PES after the convergence of the learning process. PES in μ-in is plotted along vertical axis 1402 as a function of frequency in Hz along horizontal axis 1404. Compared to plot 802 (FIG. 8), most of the RRO peaks have been significantly attenuated.

For calculating the statistical 3-σ values from the PES, the PES measurements for 100 revolutions were taken before and after the activation of the repetitive controller. Table 1 shows a comparison of the 3-σ values of RRO, NRRO and PES for a specific track.

TABLE 1

| 3-σ of | RRO | NRRO | PES (μ-inch) |
|---|---|---|---|
| Before Learning | 3.13 | 2.10 | 3.77 |
| After Learning | 0.63 | 2.18 | 2.67 |

By employing the repetitive controller, a 30% reduction in PES was obtained due to an 80% reduction of RRO. The introduction of the repetitive controller resulted in a slight increase in NRRO.

In summary, a method of correcting for written-in repeatable run-out in a disc drive (such as 100) having a servo loop (such as 400) for positioning a head (such as 110) over a rotating disc (such as 200) is provided. The rotating disc (such as 200) has at least one data track (such as 204) and servo information recorded in a plurality of servo fields (such as 206, 208) along the data track. An initial written-in repeatable run-out compensation value (such as 404) for each servo field (such as 206, 208) is computed as a function of a position error signal (such as 320) generated for each servo field (such as 206,208) during a first revolution of the disc (such as 200). The initial written-in repeatable run-out compensation value for each servo field injected into the servo loop (such as 400) during another revolution of the disc (such as 200). A compensated position error signal for each servo field is computed as a function of the initial written-in repeatable run-out compensation value for each servo field (such as 206, 208). A refined written-in repeatable run-out compensation value for each servo field is then computed as a function of the compensated position error signal for each servo field (such as 206, 208).

Another aspect of the present invention will now be explained. The comb-filter repetitive controller design of the present invention effectively eliminates periodic disturbances of a known period in the position measurements of the disc drive servo system. This is accomplished by merging the averaging ability of the frequency-domain batch process approach into the time-efficient repetitive control approach. An embodiment of the present invention uses a comb-filter incorporated with a real-time repetitive controller based on the real-time filtering concept. This comb-filter design adds the ability of separating the RRO component from the PES during the real-time WI-RRO compensation process. This approach at least minimizes the incapability of the real-time repetitive control approach to identify the RRO component beforehand. Because the RRO component can be extracted even under a noisy PES condition using the present invention, the learning gain can be increased. Thus, the RRO compensation performance can reach that of the repetitive control approach with even less time being consumed.

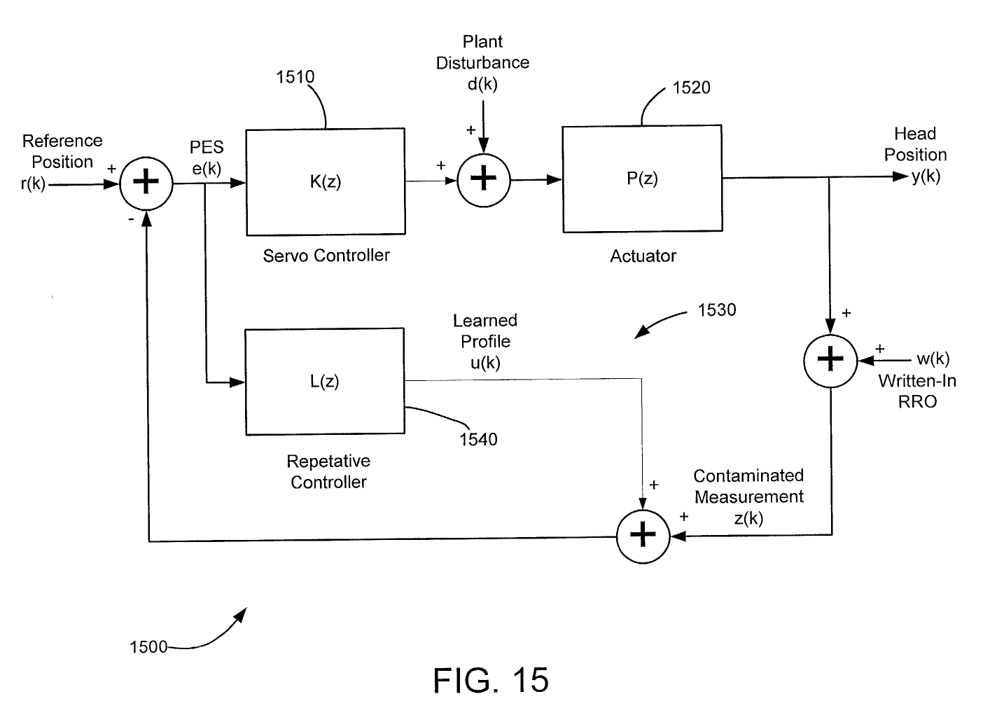

The comb-filter repetitive controller design of the present invention can be used with the real-time WI-RRO compensation structure. The present invention provides an additional comb filter to separate the RRO during the WI-RRO compensation update process as explained with reference to FIGS. 1-14. Even though the head position signal y(k) relative to ideal circular track is not measurable, the reduction in PES means signal y(k) is closer to the ideal circular track. A feedback control system 1500 according to the present invention provides the additional repetitive control loop 1540 shown in FIG. 15. The repetitive controller 1540 is represented by the function L(z). The measured PES is an input to repetitive controller 1540 and the output (of the function L(z)) is the updated learning signal u(k), which is provided into the feedback loop to attenuate the WI-RRO. If the plant disturbance signal d(k) is a pure random signal caused by windage or air turbulence, for example, the repetitive controller 1540 is able to learn the periodic components in the PES and its output signal u(k) will converge to the WI-RRO. After the converged learning sequence signal u(k) is obtained and stored as the WI-RRO profile, the repetitive controller then can be removed from the control loop if desired. The learned profile is then repeatedly used for feedforward WI-RRO cancellation in the PES measurements.

The comb-filter repetitive control function used by controller 1540 can be written as

u(k)=m(k)*q(k)*[u(k−p)+f(k)*e(k−p)] Equation (15)

where the asterisk mark (*) means a discrete-time convolution sum, and p is the time period of one revolution. Three filters m(k), q(k), and f(k) are used in the repetitive controller 1540. In addition to the two-filter structure of q(k) and f(k) used in the repetitive control module 402 of FIG. 5, the comb filter m(k) is additionally provided in repetitive controller 1540. The additional comb filter m(k) is applied to separate the RRO portion of the contaminated measurement signal z(k) for the learning update of the profile. This filter is a preferred repetition-based moving average filter. The filter design of m(k) is preferably characterized by

$$M ( z ) = \frac{1}{l} ( 1 + {z}^{- p} + {z}^{- 2 p} + ⋯ + {z}^{- ( l - 1 ) p} ) \qquad Equation ( 16 )$$

where l is the number of revolutions selected in the filtering process. Another characterization for the filter m(k) can be

$$M ( z ) = \frac{a}{1 - ( 1 - a ) {z}^{- p}}$$

where p is the time period of one revolution, and a is the selected averaging weight at 0<a<1. Decreasing the value of a will have better attenuation ability for random disturbances. However, the convergence speed will slow down. FIG. 21 is the frequency response for a=0.2 and p=224. The magnitudes at the spindle frequency and its harmonics are exactly 1 (0dB). Alternatively, any filter or filters that functions like a comb filter can be used. The filter design for m(k) preferably filters out the non-periodic portion of the contaminated measurement signal z(k) to avoid such portion from influencing the learned profile.

After taking the z-transform of Equation (15) and combining the terms, it becomes

$$L ( z ) = \frac{U ( z )}{E ( z )} = \frac{{z}^{- p} M ( z ) Q ( z ) F ( z )}{1 - {z}^{- p} M ( z ) Q ( z )} \qquad Equation ( 17 )$$

Equation (17) is the transfer function of the repetitive controller 1540 implemented as shown in FIG. 15. The block diagram of the repetitive controller 1540 is shown in FIG. 16. A first filter 1600 is shown that corresponds to filter f(k). The output of first filter 1600 is combined with the output of second filter 1610, which corresponds to filters q(k) and f(k). This combination is input to second filter 1610 as shown.

Sufficient conditions for stability of the present invention to cancel periodic measurement disturbance is developed as follows. From the block diagram in FIG. 15, the sensitivity function in Equation (2), and the repetitive controller function in Equation (17), it can be derived that

$$\begin{matrix}\{ 1 - {z}^{- p} M ( z ) Q ( z ) [ 1 - F ( z ) S ( z ) ] \} E ( z ) = \\ [ 1 - {z}^{- p} M ( z ) Q ( z ) ] [ R ( z ) - W ( z ) - P ( z ) D ( z ) ] S ( z )\end{matrix} \qquad Equation ( 18 )$$

Provided the period p is sufficiently long, the homogeneous equation can be rewritten on the left-hand side of Equation (18) as

E(z)=M(z)Q(z)[1−F(z)S(z)]z^{-P}E(z) Equation (19)

Equation (19) can be represented in the repetition domain as

Eⱼ(z)=M(z)Q(z)[1−F(z)S(z)]Eⱼ₋₁(z) Equation (20)

where j represents the repetition number. The condition for producing a monotonic decay of every steady-state discrete frequency component of the error at each repetition is

|M(e^{jωT})Q(e^{jωT})[1−F(e^{jωT})S(e^{jωT})]<1 Equation (21)

for all frequencies up to the Nyquist frequency. Here M(e^{jωT})T), Q(e^{jωT}) and F(e^{jωT}) are the steady-state frequency responses of the three filters m(k), q(k) and f (k), and S(e^{jωT}) is the steady-state frequency response of the sensitivity function of the feedback control system. The term on the left-hand side of Equation (21) also gives the convergence rate of the periodic errors at each frequency. The right-hand side of Equation (18) represents the forcing function for letting E(z) converge to a particular solution and will determine the final error level.

One purpose of filter f(k) is to adjust the magnitude and phase of an input error in order to stabilize the learning process. Ideally, it cancels the system dynamics between the repetitive control action and the influence it has on the error, so that the corrective action has the intended influence on the error. The q(k) filter preferably removes the DC component from the corrective action, so that the system aims to track the circle corresponding to the mean measured location. It is preferably a bandpass filter designed as a non-causal zero-phase FIR filter which has the general form in the z-domain as

Q(z)=aₙzⁿ+. . . +a₁z+a₀+a₁z⁻¹+. . . +aₙz⁻ⁿ, order of Q(z)=2n Equation (22)

to restrict the learning frequency region, and assist in stabilizing the system. This filter is a preferred DC-removal filter to avoid learning the DC error portion. The repetitive control function in Equation (15) can be modified to implement the non-causal q(k) filter as

u(k)=m(k)*q(k−n)*[u(k+n−p)+f(k)*e(k+n−p)] Equation (23)

In the condition of n≦p, all terms in Equation (23) are causal and the repetitive control law is feasible, i.e., can be implemented in real time.

Furthermore, from Equation (21), the preferred repetitive controller design for first filter 1600 (F(z)) for the fastest convergence of the periodic error is given by Equation (11). In practice, to reduce the amplification of random plant disturbance d(k) at the vicinity frequencies of the spindle harmonics, which is called “waterbed effect,” the filter F(z) is preferably designed as Equation (12). More repetitions of learning are expected for the satisfied convergence of the periodic errors in such designs. It also affects the final level of periodic errors.

As stated before, the additional comb filter m(k) in Equation (16) is to separate the periodic portion of the signal z(k) for learning update. This comb filter filters out the non-periodic portion of the signal z(k) to at least minimize the influence of such portion on the learned profile. A consequence is a significant relief in the waterbed effect. The more periods included in the average, the narrower the notches at the desired frequencies, and consequently there is less amplification at other frequencies due to the waterbed effect. Higher constant gain in Equation (12) can be used and faster repeatable runout attenuation rate is expected. The above repetitive controller design will be applied in the following drive implementation for WI-RRO cancellation.

The implementation of a comb-filter repetitive controller for WI-RRO compensation scheme of the present invention was applied on the same type of disc drive previously discussed. One purpose of the repetitive controller of the present invention is to cancel—or at least reduce—the WI-RRO as accurately as possible in finite revolutions from the signal z(k). The learning law in Equation (11) was used and the three filters M(z), F(z), and Q(z) were designed respectively. The filter F(z) design in Equation (12) was chosen, and the constant gain was set for c=0.5. If c is set to one, then the fastest convergence is obtained from Equation (21). But a smaller value for c can be advantageous to do slower learning but induce smaller amplification from the waterbed effect for errors at frequencies near the spindle harmonics.

The parametric transfer function of the sensitivity function inverse S⁻¹(z) used in the design was approximated by the frequency-domain curve-fitting scheme applied on the reciprocal of the frequency response of S(z). A 6^{th} order infinite-impulse- response (IIR) filter was used for fitting and the resulting transfer function \overline{S}⁻¹(z) was defined in Equation (13).

The frequency response of \overline{S}⁻¹(z) and fitting result are shown in FIG. 9. Then the final design of F(z) preferably is

F(z)=0.5×\overline{S}⁻¹(z) Equation (27)

The second filter Q(z) in this application was designed as a 60^{th} order zero-phase high-pass finite-response-response (FIR) filter with a cut-off frequency at 600 Hz. Another purpose of Q(z) is to avoid learning the peaks at the 1^{st},2^{nd} and 3^{rd} harmonics caused by the spindle motor but not the WI-RRO. They are rather attenuated by servo bandwidth than hidden from the PES. FIG. 10 shows its frequency magnitude response.

The proposed comb filter m(k) design from Equation (16) is to separate the periodic portion of the signal z(k) for WI-RRO compensation update. It averages over multiple periods in order to average out noise effects, or reduce the influence of errors at frequencies other than those being addressed. Using multiple periods produced narrower notched in the filtering. As a result, it reduces amplification of errors at other frequencies according to the waterbed effect.

In Equation (16), L=2 was selected to more clearly show the effects of the comb filter. However, a larger value for L is preferred, such as 5 and even as high as 10. Larger values are desirable, but the corresponding calculations may be impractical. The comb filter used in the experiments is defined as

$$M ( z ) = \frac{1}{2} ( 1 + {z}^{- p} ) \qquad Equation ( 28 )$$

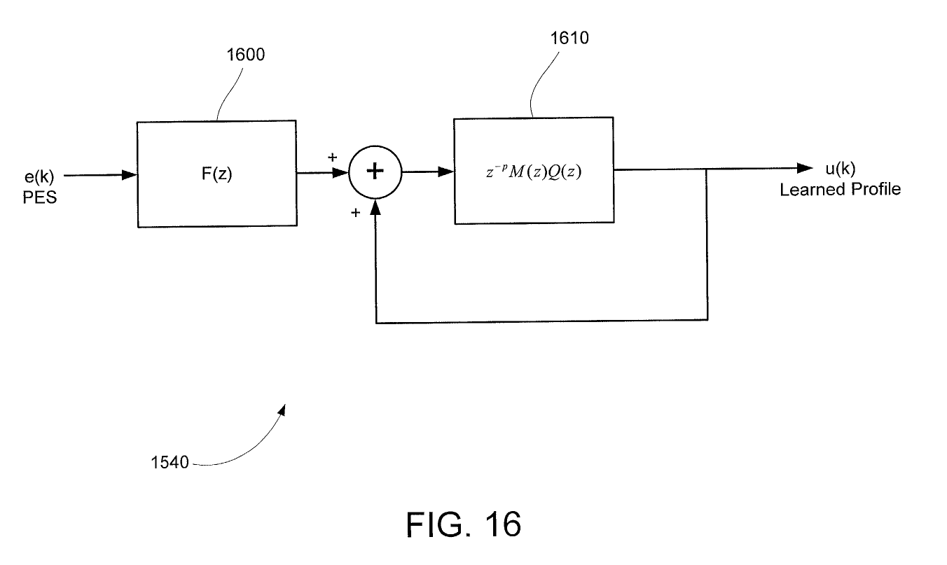

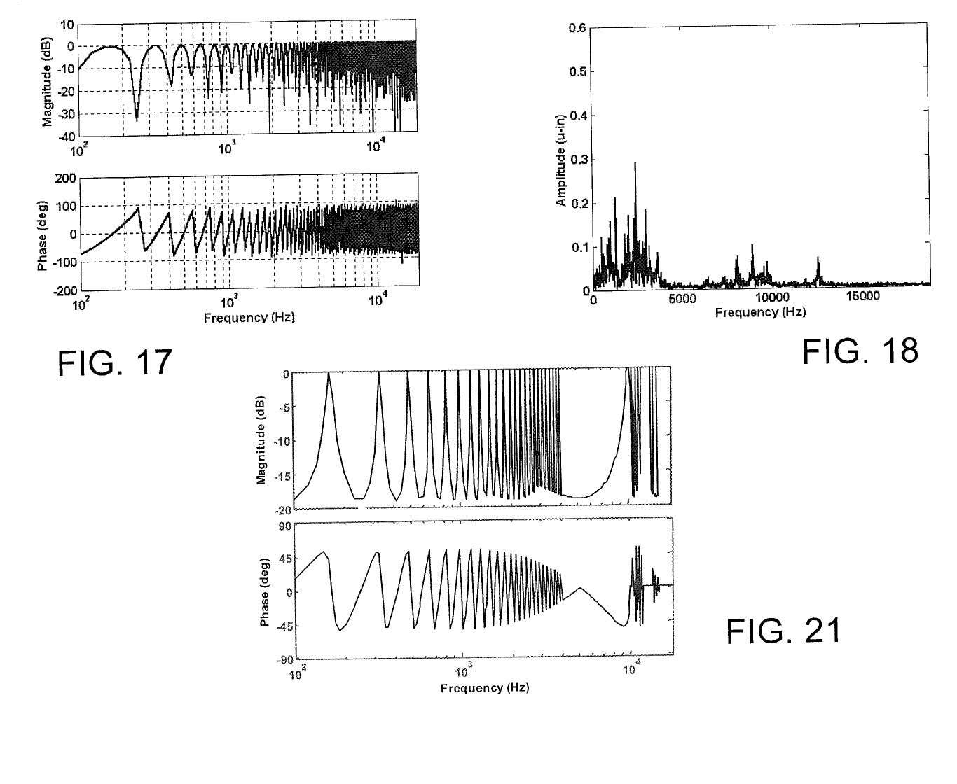

FIG. 17 is the frequency response of M(z). It preserves the components at the spindle harmonic frequencies and filters out the non-periodic portion of signal z(k) to avoid such portion coming into the learned profile.

Typically the lower constant learning gain in Equation (12), e.g. c=0.2, was used in the real-time repetitive control approach to reduce the amplification of random plant disturbance at the vicinity frequencies of spindle harmonics. Because of the use of the present invention, particularly of the addition of the comb filter in the learning structure 1530 (FIG. 15), higher gain c=0.5 was applied to accelerate the WI-RRO compensation process. FIG. 18 is a typical example of the frequency spectrum of PES after the WI-RRO compensation process of the present invention. Compared with FIG. 8, most of the RRO peaks have been significantly attenuated in finite revolutions.

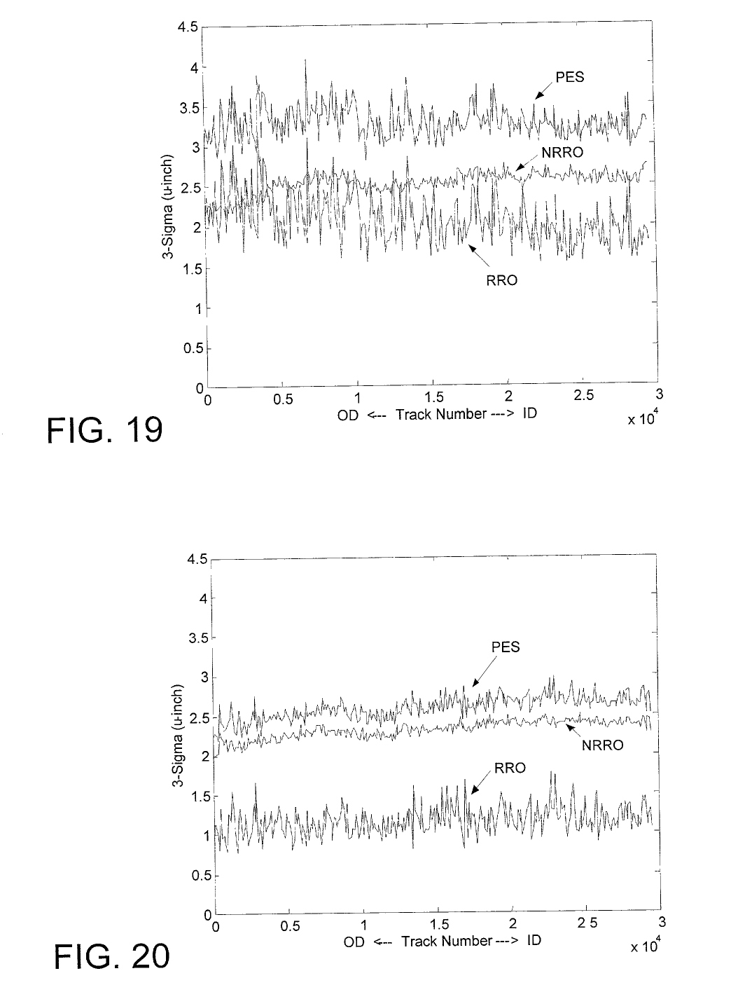

The fifth head of the disc drive, whose PES measurements are full of NRRO components, was used. FIG. 19 shows the measurements of its statistical 3-σ values of RRO, NRRO, and PES at every 100 tracks from the outer diameter to the inner diameter without WI-RRO compensation. After implementing the comb-filter real-time WI-RRO compensation scheme of the present invention, FIG. 20 shows the results of the final runout levels. Compared with FIG. 19, the 3-σ values of RRO in FIG. 20 are significantly attenuated for all tracks by using the WI-RRO compensation scheme of the present invention. The consequence is the reduction of the final PES level. The average time consumption in this process is 8.3 revolutions/track.

Three different WI-RRO compensation schemes were all tested at head 5 in the comparison to demonstrate the superiority of the proposed design. They were the frequency-domain approach, the real-time repetitive control approach, and the comb-filter repetitive control method of the present invention. Table 2 shows the experimental comparisons of the three WI-RRO compensation schemes. It shows the average of 3-σ values of RRO, NRRO, and PES after the WI-RRO compensation, and the revolutions consumed during the process. The frequency-domain approach had the best RRO performance because of the off-line averaging capability. However, the tradeoff was that more revolutions were required during the process. Compared with the frequency-domain approach, the real-time repetitive control approach of the present invention used only 12.0 revolutions and substantially accelerated the WI-RRO compensation process with similar PES performance. For the comb-filter repetitive control method of the present invention, even better PES performance was reached with the fewest revolutions consumed during the process.

TABLE 2
Comparison of the three WI-RRO compensation schemes

| 3-σ of | RRO | NRRO | PES (μ-inch) | Revs |
|---|---|---|---|---|
| No WI-RRO compensation | 2.08 | 2.52 | 3.27 | — |
| Frequency-domain | 0.81 | 2.63 | 2.75 | 28.3 |
| Real-time repetitive control | 1.15 | 2.52 | 2.77 | 12.0 |
| Comb-filter repetitive control | 1.15 | 2.30 | 2.57 | 8.3 |

The comb-filter repetitive controller design of the present invention reduces the WI-RRO in the disc drive servo system. The design is able to efficiently separate the RRO portion during the WI-RRO compensation process and accelerate the process time. Under the same conditions, the comb-filter repetitive control scheme of the present invention had the best PES performance with fewest revolutions consumed during the process.

One application of the present invention to disc drives, the repetitive control loop can be used for identifying the WI-RRO profile for every track in the factory calibration process. The learned profiles after a chosen number of revolutions is stored and written into the embedded servo patterns. Then this is WI-RRO data is applied in a feedforward cancellation during the PES measurement process. The repetitive control loop can still be used during servo tracking, and the initial values of the WI-RRO profile ensure fast convergence of the repetitive controller. The repetitive controller learns the WI-RRO profile throughout the PES measurements, and the stored profile can then be used repeatedly for feedforward WI-RRO cancellation in the PES measurements. In addition, one can use the repetitive controller during the operation in the servo track following loop.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts and values for the described variables, within the principles of the present invention to the full extent indicated by the broad general meaning of the terms in which the appended claims are expressed. For example, the particular elements may vary depending on the particular application for the servo system while maintaining substantially the same functionality without departing from the scope and spirit of the present invention. In addition, although the preferred embodiment described herein is directed to a servo loop for a disc drive system, it will be appreciated by those skilled in the art that the teachings of the present invention can be applied to other systems, without departing from the scope and spirit of the present invention. Further, the written-in repeatable run-out compensation scheme may be implemented in hardware or software. The disc drive can be based upon magnetic, optical, or other storage technologies and may or may not employ a flying slider.

What is claimed is:

1. A method of reducing a repeatable runout error comprising the steps of:
filtering a non-periodic component of a position error signal; and
determining at least one compensation value from the filtered position error signal.

2. The method of claim 1 where the filtering step uses a comb filter function.

3. The method of claim 1 where the filtering step uses a comb filter.

4. The method of claim 1 where the at least one compensation value is used to create a learned profile.

5. The method of claim 1 where the at least one compensation value is applied to a servo measurement signal.

6. The method of claim 1 where the filtering step passes signals at spindle harmonic frequencies.

7. A method of compensating for written-in repeatable run-out in a disc drive having a servo loop for positioning a head over a rotating disc, the rotating disc having at least one data track and servo information recorded in a plurality of servo fields along the at least one data track, the method comprising:
(a) filtering non-periodic components from a position error signal corresponding to a respective servo field of a plurality servo fields during a first revolution of the disc;
(b) computing an initial written-in repeatable run-out compensation value for each servo field of the plurality of servo fields as a function of a position error signal;
(c) injecting the initial written-in repeatable run-out compensation value for each servo field of the plurality of servo fields into the servo loop during another revolution of the disc;
(d) computing a compensated position error signal for each servo field of the plurality of servo fields as a function of the initial written-in repeatable run-out compensation value for each servo field; and
(e) computing a refined written-in repeatable run-out compensation value for each servo field of the plurality of servo fields as a function of the compensated position error signal for each servo field.

8. The method of claim 7 further comprising repeating steps (c), (d) and (e) iteratively with each iteration being performed during a different one of a plurality of revolutions of the disc, wherein each iteration using the refined written-in repeatable run-out compensation value for each servo field computed during an immediately previous iteration.

9. The method of claim 8 wherein steps (c), (d) and (e) are repeated iteratively until the refined written-in repeatable run-out compensation value for each servo field reaches a steady state written-in repeatable run-out compensation value.

10. The method of claim 9 wherein the steady state written-in repeatable run-out compensation value for each servo field is stored for providing written-in repeatable run out compensation during subsequent disc revolutions.

11. The method of claim 10 wherein the steady state written-in repeatable run-out compensation value for each servo field is stored on a surface of the disc.

12. A repetitive controller for a storage apparatus that performs a comb filter function to at least minimize a non-period component of a position error signal.

13. The controller of claim 12 wherein the repetitive controller includes an infinite impulse response filter that adjusts a magnitude and phase of the position error signal generated for each of a plurality of servo fields.

14. The controller of claim 12 wherein the repetitive controller includes a finite impulse response filter to limit the range of frequencies over which the repetitive controller operates.

15. The controller of claim 12 wherein the repetitive controller includes a time delay line for injecting the initial written-in repeatable run-out compensation value for each servo field computed during the first disc revolution into the servo loop during another disc revolution.

16. A feedback control system of a storage device including the controller of claim 12 where an input of the controller is coupled to receive the position error signal and an output of the controller is coupled to apply a compensation value to a measurement signal.

17. The apparatus of claim 16 where the controller can be removed from the feedback control system.

18. The apparatus of claim 16 where the repetitive controller can be used during a servo track following loop operation of the feedback control system.
